(19) United States
(12) Patent Application Publication
(10) Pub. No.: US 2024/0271291 A1
(43) Pub. Date: Aug. 15, 2024

(54) SYSTEM AND METHODS FOR WATER DESALINATION USING WATER ELECTROLYZER WASTE HEAT

(71) Applicant: Ohmium International, Inc., Newark, CA (US)

(72) Inventors: Arne Ballantine, Incline Village, NV (US); Rasool Aghatehrani, Redwood City, CA (US); Chockkalingam Karuppaiah, Fremont, CA (US)

(21) Appl. No.: 18/439,474

(22) Filed: Feb. 12, 2024

Related U.S. Application Data
(60) Provisional application No. 63/444,808, filed on Feb. 10, 2023.

(51) Int. Cl. C25B 1/04; C02F 1/42; C02F 1/44; C02F 1/72; C02F 103/08; C25B 15/021; C25B 15/08

(52) U.S. Cl. CPC C25B 1/04; C02F 1/42; C02F 1/44; C02F 1/727; C25B 15/021; C25B 15/081; C25B 15/083; C25B 15/085; C02F 2103/08; C02F 2201/007; C02F 2303/10

(57) ABSTRACT

Described herein are systems and methods for the efficient desalination and electrolysis of water to form hydrogen and oxygen gas. The systems include a desalinator, an electrolyzer, and a coolant loop. The coolant loop transfers heat produced by the electrolyzer to the desalinator, thereby reducing the energy inputs required for the desalinator to function. The methods generally include desalinating water in a desalinator, electrolyzing the desalinated water, and transferring heat generated by the electrolyzing to the desalinator.

### CROSS-REFERENCE TO RELATED APPLICATIONS

This application claims priority to U.S. Application No. 63/444,808 titled “System and Methods for Modular Water Desalination System Using Water Electrolyzer Waste Heat”, filed Feb. 10, 2023, the entire contents of which are incorporated by reference herein.

### FIELD OF THE DISCLOSURE

The present disclosure relates to desalination and electrolysis of water to form hydrogen gas and oxygen gas.

### BACKGROUND

Electrolyzer-based hydrogen plants consume purified water and electricity to generate hydrogen. The availability of the purified water is one of the most important concerns for the plant owners or the developer of new projects, particularly in locations where the renewable electricity is very cost-effective. Examples of those locations are dry geographies where solar insolation is very strong, or coastal zones where wind speed is very strong. In such areas, the availability of purified water may become a barrier for the development and expansion of the hydrogen plants. Water desalination methods such as distillation-based desalination systems and membrane-based technologies are used widely. However, the desalination process is energy-intense and therefore expensive to operate.

### SUMMARY OF DISCLOSURE

Provided herein are systems for efficiently desalinating and electrolyzing water. The systems include a desalinator to purify saline water fluidly connectable to a first water source; an electrolyzer to electrolyze the desalinated water, the electrolyzer fluidly connectable to the desalinator and to a purified water source; and a coolant loop thermally coupled to the desalinator and to the electrolyzer, the coolant loop operable to transfer heat produced by the electrolyzer to the desalinator. The coolant loop may include a coolant storage vessel fluidly connected to the coolant loop to store coolant at a low temperature. The coolant may comprise water, a glycol (such as ethylene glycol), or a combination thereof. The heat produced by the electrolyzer is preferably the only heat source used to transfer heat to the desalinator. The first water source may comprise sea water, river water, well water, industrial wastewater, non-industrial wastewater, city water, or a combination thereof. The electrolyzer may be a proton exchange membrane (PEM) electrolyzer, an anion exchange membrane (AEM) electrolyzer, a solid oxide electrolyzer, or an alkaline electrolyzer.

The systems may further include an ion exchange bed fluidly connectable to the desalinator and to the electrolyzer, whereby the ion exchange bed receives desalinated water from the desalinator and provides purified water to the electrolyzer. The systems may further include a desalinated water storage vessel fluidly connected to the desalinator to store desalinated water produced by the desalinator. In some embodiments, the system may include a plurality of desalinator, a plurality of electrolyzers, or a combination thereof. Each of the plurality of desalinators and each of the plurality of electrolyzers may be located on different floors of a multi-floor structure. The system may be located on an offshore platform.

Further provided herein are methods for desalinating and electrolyzing water. The methods may include (a) desalinating water in a desalinator from a first water source to produce desalinated water; (b) electrolyzing the desalinated water to produce hydrogen and oxygen; and (c) transferring heat produced by the electrolyzing to the desalinator. Preferably, the heat produced by the electrolyzing is the only heat provided to the desalinator. The methods may further include purifying the desalinated water in an ion exchange bed. The methods may further include storing the desalinated water in a desalinated water storage vessel. Step (c) may be accomplished in a coolant loop. The methods may further include injecting the oxygen generated by the electrolyzer into a desalination effluent stream. The methods may further include electrolyzing water from a purified water source prior to step (a).

### BRIEF DESCRIPTION OF THE FIGURES

FIG. 1 shows a flow diagram of a system of the present disclosure.

FIG. 2 shows a flow diagram of a system of the present disclosure with the addition of an ion exchange bed.

FIG. 3 shows a flow diagram of a system of the present disclosure, wherein oxygen generated by the electrolyzer is injected into the desalination effluent.

### DETAILED DESCRIPTION

Systems and methods are provided herein for desalinating and electrolyzing water to produce hydrogen. Waste heat produced by the electrolyzer is used to perform the desalination, which requires large amounts of heat. In preferred embodiments, the waste heat produced by the electrolyzer is the only heat source provided to the desalinator to perform the desalination. The systems of the present disclosure therefore significantly reduce the operating costs of desalinating water for use in an electrolyzer and significantly increases the energy efficiency of the desalinator.

Preferably, the systems of the present disclosure and the components thereof are modular. As used herein, “modular” refers to a system or a system component that is manufactured to be readily installed and operated at a site. In other words, a modular system or system component may be delivered to a site in a “ready-to-use” state, rather than having to construct the system or system component at the site. The modular systems may be deliverable by truck and may be moveable via a forklift or even by human power. The modular design of the systems and system components described herein allows the ease of installation, operation, and maintenance of the desalination system to further decrease the operation and maintenance cost and to increase the system availability.

### I. System

The systems of the present disclosure generally include a desalinator to purify saline water fluidly connectable to a first water source, an electrolyzer to electrolyze water, fluidly connectable to the desalinator and to a purified water source; and a coolant loop thermally coupled to the desalinator and to the electrolyzer, the coolant loop operable to transfer heat produced by the electrolyzer to the desalinator.

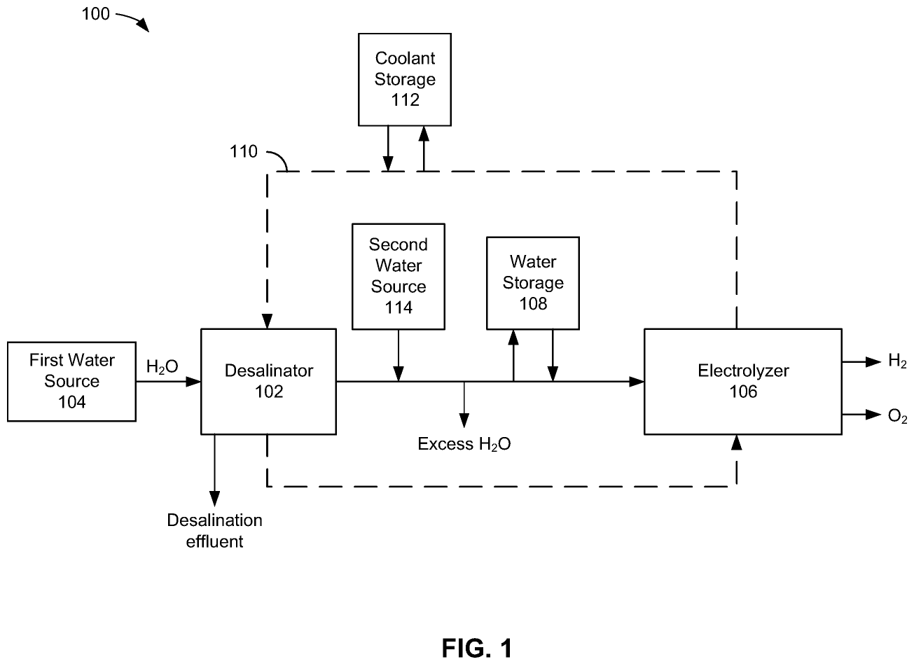

Referring to FIG. 1, the system 100 includes a desalinator 102 is fluidly connected to a first water source 104. The first water source 104 generally is an unpurified water source and may include sea water, saline water, river water, well water, industrial wastewater, non-industrial wastewater, city water, or a combination thereof. The first water source 104 may be a water storage system (e.g., a tank or vessel), or it may be a natural water source (e.g., an ocean or river) that feeds directly into the desalinator 102. One or more pumps (not shown) may be used transport the water from the first water source to the desalinator 102 and to pressurize the water entering the desalinator 102. In some embodiments, the system of the present disclosure may include a plurality of desalinators, each of which may be fluidly connected to the first water source. In such embodiments, each desalinator may have its own connection to the first water source, or all of the desalinators may be fluidly connected to the first water source through a common pipe.

The desalinator 102 may include a membrane-based desalination system; for example, the desalinator 102 may one or more methods of desalination known in the art, such as distillation (e.g., solar distillation, evaporation, vacuum distillation, multi-stage flash distillation, membrane distillation), osmosis (e.g., reverse osmosis), freeze-thaw, electrodialysis, or microbial distillation, or combinations thereof. Preferably, the desalination system utilizes a membrane-based system, such as a membrane distillation system, a reverse osmosis desalination system or an electrodialysis desalination system. Although membrane-based desalinators still require a high energy input, the amount of energy required is less than that of other desalination systems, such as distillation-based desalinators. Due to the high salt content of seawater and saline water, the desalinator 102 is preferably made of highly corrosion-resistant material (e.g., stainless steel, aluminum, titanium, plastics, etc.).

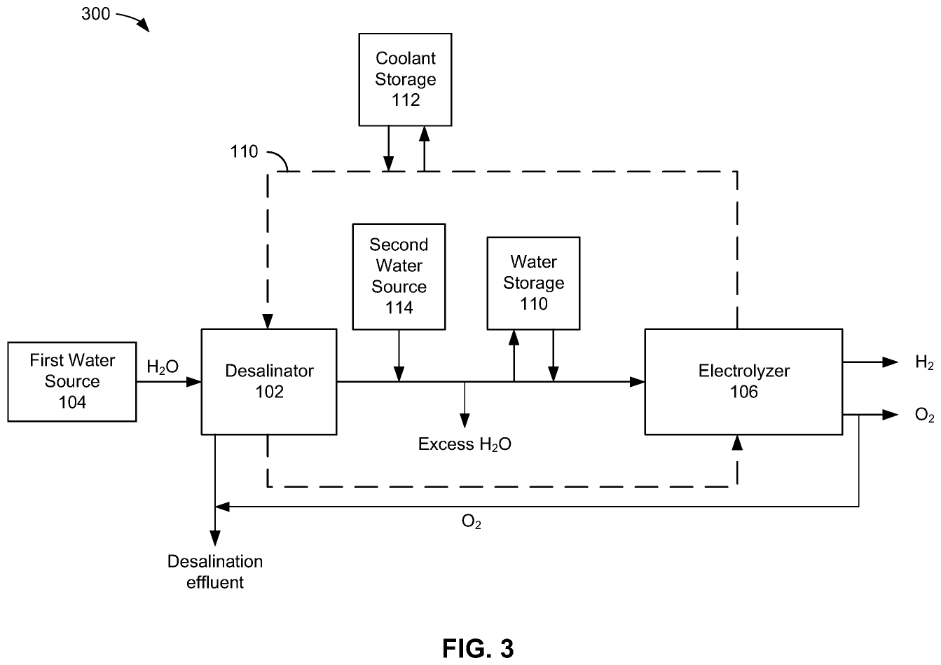

The desalinator 102 produces a desalinated water stream that is provided to the electrolyzer 106 or that may be stored in a water storage vessel 108. If excess desalinated water is produced that cannot be used for electrolysis or stored, the excess desalinated water may be sent to other processes or uses. The desalinated water may have a conductivity from about 10 μS/m³ to about 50 μS/m³. The desalinator 102 also produces a desalinator effluent that generally comprises brine. The effluent may be discharged to a natural water source or may be processed for other purposes. In some embodiments such as the system 300 of FIG. 3, oxygen produced by the electrolyzer 106 may be injected into the desalinator effluent. This is beneficial in system where the desalinator effluent may contain organic compounds. The injected oxygen helps to oxidize and reduce the organic compounds, thereby making the effluent safer for discharge.

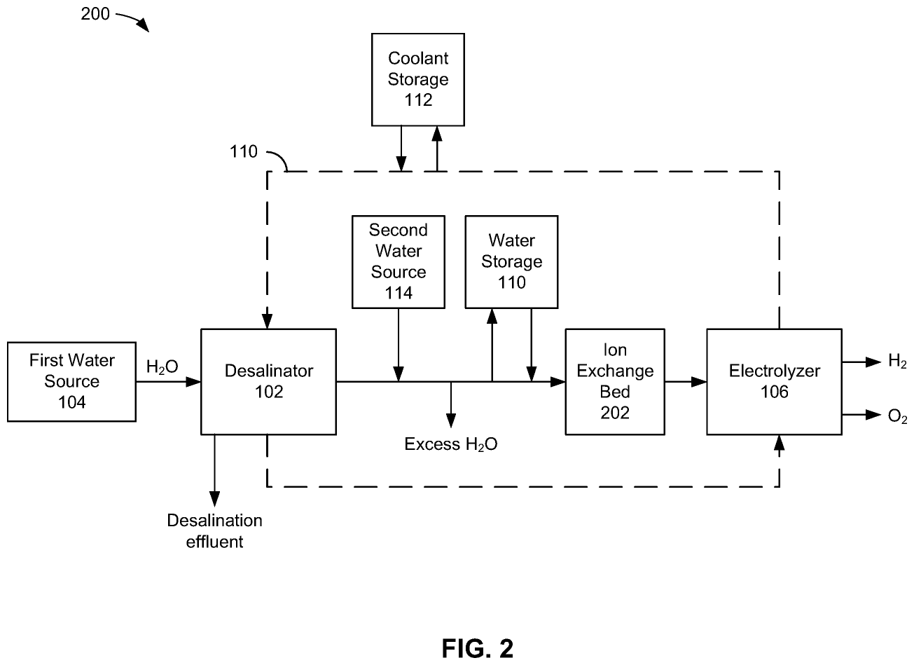

In some embodiments, such as in FIG. 2, the system 200 may include an ion exchange bed 202 to further purify the desalinated water prior to electrolysis in the electrolyzer 106. The ion exchange bed 202 may comprise one or more ion exchange resins located within distinct compartments in the ion exchange bed 202. For example, a resin with a high ion exchange rate may be located in a first compartment of the ion exchange bed 202, whereas a second resin with a low ion exchange rate may be located in a second compartment of the ion exchange bed 202. A controller may be operable to direct the flow of the water to one or more of the compartments based on the needs of the system. The temperature of the desalinated water flowing through or flowing from the ion exchange bed 202 may be increased or decreased via one or more heat exchangers. The heat exchanger(s) may comprise a heat exchange fluid such as water, steam, glycol, air, a silicon fluid, a molten salt, or other heat exchange fluids known in the art. In some embodiments, the heat exchanger(s) may be in thermal communication with the coolant loop 110, and may transfer heat to or from the coolant flowing through the coolant loop 110. In some embodiments, the system 200 may comprise a plurality of ion exchange beds fluidly connected in series or in parallel.

The ion exchange bed 202 comprises an ion exchange resin, preferably in the form of beads, comprising a cation exchange media and an anion exchange media. Generally, the ion exchange resin may conduct an H⁺/OH⁻ exchange; however, it is also envisioned that the ion exchange resin may also or alternatively conduct NH₄⁺/OH⁻ exchange, weak acid/weak base exchange, or other exchange mechanisms. The ion exchange resin is preferably capable of withstanding temperatures of up to 100° C., or more preferably up to 90° C. The relative amounts of cation exchange media and anion exchange media may be adjusted based on the known or predicted quality of the water used in the system. Additionally, the type of ion exchange resin used may be chosen based upon impurities of the water in the region in which the system operates. In some embodiments, the ion exchange resin comprises a sulfonic acid functional group, a trimethylammonium functional group, a quaternary ammonium functional group, and combinations thereof. The ion exchange resin may comprise a polymer matrix structure, such as cross-linked divinylbenzene or cross-linked polystyrene. Some non-limiting examples of ion exchange resins that may be used in the ion exchange bed include Dupont's AmberTec™ UP6150 H/OH Ion Exchange Resin, Dupont's AmberLite™ MB20 H/OH Ion Exchange Resin, and Thermax's TULSION® MB-1518.

The desalinated water generated by the desalinator 102 may be provided directly to the electrolyzer 106. Alternatively, a portion of the desalinated water may be provided to the ion exchange bed 202. In such embodiments, the ion exchange bed 202 may be connected to the desalinator 102 and the electrolyzer 106. The portion of desalinated water provided to the ion exchange bed 202 may be predetermined based on the conductivity of the water entering the electrolyzer 106 as measured by one or more conductivity meters. Conductivity meters and methods of measuring conductivity are generally well-known in the art. One or more flow control valves may adjust the flow of desalinated water and deionized water entering the electrolyzer 106 based on an input received from the conductivity meter(s). The flow control valves may be any valve known in the art suitable for controlling the flow of the water.

Turning back to FIG. 1, The system 100 also includes an electrolyzer 106 to electrolyze the desalinated water to generate hydrogen gas and oxygen gas. The electrolyzer 106 may include a single electrochemical cell for electrolyzing the water or may include a plurality of electrochemical cells. The electrolyzer 106 may include a proton exchange membrane (PEM) electrolyzer, an anion exchange membrane (AEM) electrolyzer, a solid oxide electrolyzer, or an alkaline electrolyzer. A PEM electrolyzer may comprise any suitable proton exchange (e.g., hydrogen ion transport) polymer membrane, such as sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystyrene (S-SEBS), or, in some examples, a Nafion® membrane composed of sulfonated tetrafluoroethylene based fluoropolymer-copolymer having a formula C₇HF₁₃O₅S·C₂F₄, and combinations thereof. An AEM electrolyzer may comprise any suitable anion exchange polymer membrane, such as imidazolium functionalized styrene polymers including cross-linked polystyrene (e.g., polystyrene crosslinked with divinylbenzene), sodium polystyrene sulfonate, PolyAMPS, polyAPTAC, polysulfone and derivatives thereof, polymers with quaternary phosphonium groups, polymers with anion exchange groups incorporated into the polymeric backbone, and other anion exchange materials known in the art and combinations thereof. In some embodiments, the system 100 may include a plurality of electrolyzers, each fluidly connected to a single desalinator or to a plurality of desalinators.

A second water source 114 may be fluidly connected to the electrolyzer 106. The second water source 114 preferably includes a source of purified water suitable for use in the electrolyzer that does not require desalination. This water source is preferably used only when the desalinator 102 is offline or otherwise not functioning. In particular, the second water source 114 may be used during start up of the system, when the coolant in the coolant loop has not absorbed sufficient heat from the electrolyzer 106 to provide to the desalinator 102.

The system 100 further includes a coolant loop 110. The coolant loop 110 is operable to circulate a coolant fluid from the electrolyzer 106 to the desalinator 102. The coolant loop 110 transports the coolant through one or more pipes via one or more pumps (not shown). The coolant loop 110 also includes a heat exchanger thermally coupled to the electrolyzer 106 and a heat exchanger thermally coupled to the desalinator 102. The heat exchangers are preferably liquid-liquid heat exchangers, e.g., shell and tube heat exchangers, although those skilled in the art will appreciate that multiple heat exchanger types may be used to effectively transfer heat to the coolant fluid.

Accordingly, the coolant loop 110 operates by circulating the coolant to the electrolyzer 106, where heat generated by the electrolyzer 106 is transferred to and absorbed by the coolant. The coolant is then pumped to the desalinator 102, where the heat absorbed by the coolant is transferred to the desalinator 102. In preferred embodiments, the heat transferred from the coolant is the only source of heat provided to the desalinator 102.

In some embodiments, the coolant loop 110 may be thermally coupled to a plurality of electrolyzers, a plurality of desalinators, or both. The coolant loop 110 may be thermally coupled to each of the plurality of electrolyzers or each of the plurality of desalinators in series or in parallel.

The coolant used in the coolant loop may comprise any heat exchange fluid known in the art. Preferably, the coolant comprises water, glycol (such as ethylene glycol), or a combination thereof.

The system 100 may additionally include one or more coolant storage vessels 112 fluidly connected to the coolant loop. The coolant storage vessel 112 may be used to store additional coolant, and thereby additional heat, when additional heat is available from the electrolyzer. A control system may be implemented to monitor and adjust the flow of the coolant in the coolant loop 110 to capture additional heat by storing coolant.

The coolant loop 110 may further comprise one or more heat sinks (not shown) to provide additional cooling to the coolant fluid. The heat sinks are thermally coupled to the coolant loop. The one or more heat sinks may include a radiator, geothermal cooling, seawater cooling, and other heat sinks known in the art. The heat sinks may not be thermally coupled to any other system components, such as the desalinator.

The coolant loop 110 may also comprise a heating element (not shown) to provide heat sufficient to prevent freezing during off-line conditions when the ambient temperature is below freezing. In such embodiments, the heater may not be operated at times when the electrolyzer 106 is in operation, as the electrolyzer 106 will provide sufficient heat to prevent freezing and to provide heat to the desalinator 102. Thus, the coolant loop 110 may be operational to provide heat to both the electrolyzer 106 and the desalinator 102 to prevent freezing during off-line conditions.

The system may include one or more controllers operable to control various aspects of the system, such as the flow rate of water from the first water source 104 entering the desalinator 102, flow rates of desalinated water entering the electrolyzer 106, and the flow rate of the coolant in the coolant loop 110. By controlling these parameters, the efficiency of producing hydrogen and desalinated water can be maximized. In some embodiments, the system may include a first control system to control the electrolyzer(s) and a separate control system to control the desalinator(s).

Due to the modularity of the system and the system components, the system may be located onshore near a body of water such as an ocean or a river, or the system may be located on an offshore platform. These embodiments are particularly beneficial for providing electricity to the electrolyzer and the desalinator, as renewable sources such as solar and wind are particularly efficient in these locations.

The system may also be located in a multi-floor structure such as a building. In particular, this enables implementation of the systems described herein in brownfield projects; i.e., in areas where land or structures are abandoned or underutilized due to e.g., pollution or other hazards. In such embodiments, the system may include a plurality of electrolyzers and a plurality of desalinators as discussed above. Certain floors of the multi-floor structure may include only electrolyzers, only desalinators, or a combination of electrolyzers and desalinators. Other floors may include auxiliary equipment such as power conditioning equipment, controllers, additional water purification equipment (e.g., ion exchange beds), storage (e.g., hydrogen storage, oxygen storage, water storage, brine storage, electricity storage, coolant storage, etc.) and other auxiliary equipment or combinations thereof.

### II. Methods

Further provided herein are methods for efficiently desalinating and electrolyzing water. The methods may be accomplished using any of the systems described hereinabove. Generally, the methods include (a) desalinating water in a desalinator from a first water source to produce desalinated water; (b) electrolyzing the desalinated water to produce hydrogen and oxygen; and (c) transferring heat produced by the electrolyzing to the desalinator. Preferably, the heat transferred in step (c) is the only heat provided to the desalinator.

In step (a), the desalinating may be accomplished using any of the desalinators described hereinabove. The desalinating removes dissolved minerals from the water provided by the first water source, thereby providing a desalinated water stream that may be suitable for electrolysis. The first water source may include sea water, river water, well water, industrial wastewater, non-industrial wastewater, city water, or a combination thereof. The method may include pumping water from the first water source to the desalinator for electrolysis. The desalinating also forms an effluent stream containing brine, which may be discharged or further processed for other uses. For example, the brine may be processed to recover minerals contained in the brine.

The methods may further include storing the desalinated water in a water storage vessel. The stored desalinated water may be used when the desalinator is off-line or when capacity of desalinated water otherwise runs low. The methods may also include providing the desalinated water to one or more other uses or applications, such as providing the desalinated water as drinking water.

In step (b), the electrolyzing may be accomplished using any of the electrolyzers described hereinabove. The hydrogen and oxygen produced in the electrolyzer are in a gaseous state. The methods may further comprise storing the hydrogen and/or the oxygen generated by the electrolyzing. In some embodiments, the method may further comprise injecting the oxygen produced in the electrolyzer into the desalinator effluent stream. This may be accomplished by using a diffuser or aerator to absorb the oxygen into the desalinator effluent stream.

The method may further comprise purifying the desalinated water in an ion exchange bed. This purifying step removes additional impurities not removed by the desalinator and ensures optimal operation of the electrolyzer. The desalinated water purified by the ion exchange bed is then provided to the electrolyzer for electrolysis.

In step (c), the transferring may be accomplished by a coolant loop comprising a coolant. The coolant loop and the coolant may be any described hereinabove. Specifically, the transferring is accomplished by transferring heat produced by the electrolyzer to the coolant, pumping the coolant through the coolant loop, and transferring heat to the desalinator from the coolant. The coolant is then pumped back to the electrolyzer to repeat the cycle.

The methods may further include storing the coolant in a low temperature state (e.g., about 25-40° C.). The coolant may be stored in a coolant storage vessel as described hereinabove. The methods may further include cooling the coolant in one or more heat sinks. The heat sinks may be any of the heat sinks described hereinabove. For example, when the heat sink is a radiator, the coolant may be pumped through the radiator to transfer heat from the coolant to the ambient air surrounding the system.

The methods may further include electrolyzing water from a purified water source prior to desalinating of step (a). As noted above, this is particularly useful upon startup of the system when the coolant may not have enough absorbed heat to provide to the desalinator to provide a source of desalinated water to the electrolyzer. Additionally, this is also useful if the rate of production of desalinated water is not sufficient to meet the demand of the electrolyzers.

### Enumerated Embodiments

Embodiment 1: A system for desalinating and electrolyzing water, the system comprising:
a desalinator to purify saline water fluidly connectable to a first water source;
an electrolyzer to electrolyze water, fluidly connectable to the desalinator and to a purified water source; and
a coolant loop thermally coupled to the desalinator and to the electrolyzer, the coolant loop operable to transfer heat produced by the electrolyzer to the desalinator.

Embodiment 2: The system of embodiment 1, wherein the heat produced by the electrolyzer is the only heat source used to transfer heat to the desalinator.

Embodiment 3: The system of embodiment 1 or embodiment 2, further comprising an ion exchange bed fluidly connectable to the desalinator and to the electrolyzer, whereby the ion exchange bed receives desalinated water from the desalinator and provides purified water to the electrolyzer.

Embodiment 4: The system of any one of embodiments 1-3, wherein the first water source comprises sea water, river water, well water, industrial wastewater, non-industrial wastewater, city water, or a combination thereof.

Embodiment 5: The system of any one of embodiments 1-4, wherein the electrolyzer includes a proton exchange membrane (PEM) electrolyzer, an anion exchange membrane (AEM) electrolyzer, a solid oxide electrolyzer, or an alkaline electrolyzer.

Embodiment 6: The system of any one of embodiments 1-5, further comprising a desalinated water storage vessel fluidly connected to the desalinator to store desalinated water produced by the desalinator.

Embodiment 7: The system of any one of embodiments 1-6, wherein the coolant loop includes a coolant storage vessel fluidly connected to the coolant loop to store coolant at a low temperature.

Embodiment 8: The system of claim 7, wherein the coolant comprises water, ethylene glycol, or a combination thereof.

Embodiment 9: The system of any one of embodiments 1-8, wherein the system is located on an offshore platform.

Embodiment 10: The system of any one of embodiments 1-9, wherein the system includes a plurality of desalinators and a plurality of electrolyzers.

Embodiment 11: The system of embodiment 10, wherein each of the plurality of desalinators and each of the plurality of electrolyzers are located on different floors of a multi-floor structure.

Embodiment 12: A method for desalinating and electrolyzing water, the method comprising:
a) desalinating water in a desalinator from a first water source to produce desalinated water;
b) electrolyzing the desalinated water to produce hydrogen and oxygen; and
c) transferring heat produced by the electrolyzing to the desalinator.

Embodiment 13: The method of embodiment 12, wherein the heat produced by the electrolyzing is the only heat provided to the desalinator.

Embodiment 14: The method of embodiment 12 or 13, further comprising (d) purifying the desalinated water in an ion exchange bed.

Embodiment 15: The method of any one of embodiments 12-14, wherein the first water source comprises sea water, river water, well water, industrial wastewater, non-industrial wastewater, city water, or a combination thereof.

Embodiment 16: The method of any one of embodiments 12-15, further comprising storing the desalinated water in a desalinated water storage vessel.

Embodiment 17: The method of any one of embodiments 12-16, wherein step (c) is accomplished in a coolant loop, the coolant loop comprising a coolant.

Embodiment 18: The method of embodiment 17, wherein the coolant fluid comprises water, ethylene glycol, or a combination thereof.

Embodiment 19: The method of any one of embodiments 12-18, further comprising injecting the oxygen into a desalination effluent stream.

Embodiment 20: The method of any one of embodiments 12-19, further comprising electrolyzing water from a purified water source prior to step (a).

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

The method steps of the implementations described herein are intended to include any suitable method of causing such method steps to be performed, consistent with the patentability of the following claims, unless a different meaning is expressly provided or otherwise clear from the context. For example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

1. A system for desalinating and electrolyzing water, the system comprising:
a desalinator to purify saline water fluidly connectable to a first water source;
an electrolyzer to electrolyze water, fluidly connectable to the desalinator and to a purified water source; and
a coolant loop thermally coupled to the desalinator and to the electrolyzer, the coolant loop operable to transfer heat produced by the electrolyzer to the desalinator.

2. The system of claim 1, wherein the heat produced by the electrolyzer is the only heat source used to transfer heat to the desalinator.

3. The system of claim 1, further comprising an ion exchange bed fluidly connectable to the desalinator and to the electrolyzer, whereby the ion exchange bed receives desalinated water from the desalinator and provides purified water to the electrolyzer.

4. The system of claim 1, wherein the first water source comprises sea water, river water, well water, industrial wastewater, non-industrial wastewater, city water, or a combination thereof.

5. The system of claim 1, wherein the electrolyzer includes a proton exchange membrane (PEM) electrolyzer, an anion exchange membrane (AEM) electrolyzer, a solid oxide electrolyzer, or an alkaline electrolyzer.

6. The system of claim 1, further comprising a desalinated water storage vessel fluidly connected to the desalinator to store desalinated water produced by the desalinator.

7. The system of claim 1, wherein the coolant loop includes a coolant storage vessel fluidly connected to the coolant loop to store coolant at a low temperature.

8. The system of claim 7, wherein the coolant comprises water, ethylene glycol, or a combination thereof.

9. The system of claim 1, wherein the system is located on an offshore platform.

10. The system of claim 1, wherein the system includes a plurality of desalinators and a plurality of electrolyzers.

11. The system of claim 10, wherein each of the plurality of desalinators and each of the plurality of electrolyzers are located on different floors of a multi-floor structure.

12. A method for desalinating and electrolyzing water, the method comprising:
a) desalinating water in a desalinator from a first water source to produce desalinated water;
b) electrolyzing the desalinated water to produce hydrogen and oxygen; and
c) transferring heat produced by the electrolyzing to the desalinator.

13. The method of claim 12, wherein the heat produced by the electrolyzing is the only heat provided to the desalinator.

14. The method of claim 12, further comprising (d) purifying the desalinated water in an ion exchange bed.

15. The method of claim 12, wherein the first water source comprises sea water, river water, well water, industrial wastewater, non-industrial wastewater, city water, or a combination thereof.

16. The method of claim 12, further comprising storing the desalinated water in a desalinated water storage vessel.

17. The method of claim 12, wherein step (c) is accomplished in a coolant loop, the coolant loop comprising a coolant.

18. The method of claim 17, wherein the coolant fluid comprises water, ethylene glycol, or a combination thereof.

19. The method of claim 12, further comprising injecting the oxygen into a desalination effluent stream.

20. The method of claim 12, further comprising electrolyzing water from a purified water source prior to step (a).
